(19) United States
(12) Patent Application Publication
(10) Pub. No.: US 2016/0265278 A1
(43) Pub. Date: Sep. 15, 2016

(54) LADDER STIFFENING SYSTEM AND METHOD

(71) Applicant: Alpine Training Services LLC, Sun Valley, CA (US)

(72) Inventor: Darren JEFFREY, Phelan, CA (US)

(21) Appl. No.: 15/065,666

(22) Filed: Mar. 9, 2016

Related U.S. Application Data
(60) Provisional application No. 62/131,204, filed on Mar. 10, 2015.

(51) Int. Cl. E06C 7/10

(52) U.S. Cl. CPC E06C 7/10

(57) ABSTRACT

A system for stiffening a ladder is provided and includes a bracket assembly securable to the ladder and including a main body portion and an extension member coupled to the main body portion. The extension member is movable between a stowed position and a deployed position and includes a distal end defining a guide portion. A line has a first end securable to one end of the ladder and a second end securable to an opposite end of the ladder. The line is extendable through and supportable by the guide portion. The extension member is moveable from the stowed position to the deployed position to apply tension to the line such that the bracket, the line, and the ladder define a triangulated truss structure.

### CROSS-REFERENCE TO RELATED APPLICATION

This application claims the benefit of and priority to U.S. Provisional Patent Application No. 62/131,204, filed Mar. 10, 2015, the entire contents of which are hereby incorporated by reference herein.

### BACKGROUND

The present disclosure relates to ladder construction, and more specifically, to a system for stiffening an extension-style ladder.

Extension ladders are well known tools for gaining access to elevated locations. A typical extension ladder includes two pieces that are slidable relative to one another to adjust an overall height of the ladder. Many different constructions have been proposed but today virtually all extension ladders included two substantially equal length ladder sections, with each section comprising a pair of spaced apart parallel beam members joined by a plurality of equally spaced apart ladder rungs. The ladder sections are typically joined by yokes or sleeves fixed to one of the ladder sections through or along which the other ladder section may slide.

Substantial engineering and design effort has gone into strengthening the beams, yokes, and sleeves used in conventional extension ladders to improve strength and reduce weight. Even with modern materials and manufacturing techniques, achieving a suitably strong ladder with minimal weight generally requires compromises in one criteria or the other. This is especially true for ladders designed for use in tactical and/or law enforcement applications. Such ladders must be extremely light and rapidly deployable, yet suitably strong to support multiple individuals typically weighing anywhere from 180 to 220 lbs. along with all the gear they are required to carry for a given mission. Although very lightweight ladders are currently in use in the tactical and law enforcement environments, these ladders leave much to be desired in the way of strength and stability. In fact, when questioned about the most dangerous things they do on certain missions, multiple members of the special forces have been known to cite use of the standard-issue tactical ladder, for example to breach and enter a commercial airplane, as among the most dangerous tasks they perform. Although known tactical ladders could easily be strengthened by adding or changing material, such methods will increase the already considerable weight (from a tactical perspective) of the ladder.

### SUMMARY

In some aspects, a bracket assembly for stiffening a ladder is provided and includes a main body portion securable to the ladder and defining an axis, and an extension member coupled to the main body portion and movable with respect to the main body portion between a stowed position and a deployed position. The extension member includes a distal end defining a guide portion that is closer to the axis when the extension member is in the stowed position than the guide portion is to the axis when the extension member is in the deployed position.

The main body portion may include an outboard plate, an inboard plate, and at least one securement opening extending through at least one of the outboard plate and the inboard plate for securement of the main body portion. The main body portion may include a generally U-shaped cross section including a top plate extending substantially parallel to the axis and positioned opposite the securement opening. The extension member may be substantially parallel to the axis when in the stowed position and substantially perpendicular to the axis when in the deployed position. The extension member may include a proximal end defining a stop member for securing the extension member in one of the stowed position and the deployed position. The assembly may further comprise a stowed position stop bracket coupled to the main body portion and a deployed position stop bracket coupled to the main body portion. The stop member may be securable to the stowed position stop bracket to secure the extension member in the stowed position and may further be securable to the deployed position stop bracket to secure the extension member in the deployed position. The assembly may further comprise a first locking pin extending through the main body portion and a second locking pin selectively extendable through either the stop member and the stowed position stop bracket to secure the extension member in the stowed position, or the stop member and the deployed position stop bracket to secure the extension member in the deployed position. In some embodiments, the extension member may be pivotally coupled to the main body portion for movement between the stowed and deployed positions. The distal end of the extension member may include a handle, and a portion of the handle may define the guide portion.

In other aspects, a system for stiffening a ladder is provided and includes a bracket assembly securable to the ladder and including a main body portion and an extension member coupled to the main body portion. The extension member is movable between a stowed position and a deployed position and includes a distal end defining a guide portion. A line has a first end securable to one end of the ladder and a second end securable to an opposite end of the ladder. The line is extendable through and supportable by the guide portion. The extension member is moveable from the stowed position to the deployed position to apply tension to the line.

When the bracket assembly is secured to a middle portion of the ladder, the extension member is in the deployed position, the first end of the line is secured to the one end of the ladder, the second end of the line is secured to the opposite end of the ladder, and the line is extending through and over the guide portion, the line, the bracket assembly, and the ladder may cooperate to define a triangulated truss structure. The main body portion may define an axis, and the extension member may be substantially parallel to the axis when in the stowed position and substantially perpendicular to the axis when in the deployed position. The main body portion may include an outboard plate, an inboard plate, and at least one securement opening extending through at least one of the outboard plate and the inboard plate for securement of the main body portion to the ladder. The extension member may include a proximal end defining a stop member for securing the extension member in one of the stowed position and the deployed position. The bracket assembly may also include a stowed position stop bracket coupled to the main body portion and a deployed position stop bracket coupled to the main body portion such that the stop member is securable to the stowed position stop bracket to secure the extension member in the stowed position and securable to the deployed position stop bracket to secure the extension member in the deployed position. The bracket assembly may further include a first locking pin extending through the main body portion and a second locking pin selectively extendable through either the stop member and the stowed position stop bracket to secure the extension member in the stowed position, or the stop member and the deployed position stop bracket to secure the extension member in the deployed position. The extension member may be pivotally coupled to the main body portion for movement between the stowed and deployed positions. The distal end of the extension member may include a handle, and a portion of the handle may define the guide portion. The system may further include a coupling member securable to the opposite end of the ladder and including a line securement member for securing the second end of the line to the coupling member. The second end of the line may include a plurality of indicia at predetermined distances from the first end of the rope, and each indicia may correspond to a respective length to which the ladder may be adjusted.

### BRIEF DESCRIPTION OF THE DRAWINGS

FIG. 1 is perspective view of an exemplary ladder stiffening main bracket assembly in a stowed configuration.

FIG. 2 is an enlarged perspective view of an outboard side of the main bracket assembly of FIG. 1 in the stowed configuration.

FIG. 3 is an enlarged perspective view of an inboard side of the main bracket assembly of FIG. 1 in the stowed configuration.

FIG. 4 is a perspective view of the main bracket assembly of FIG. 1 in a deployed configuration.

FIG. 5 is an enlarged perspective view of the outboard side of the main bracket assembly of FIG. 1 in an intermediate configuration between the stowed configuration and the deployed configuration.

FIG. 6 is an enlarged perspective view of the inboard side of the main bracket assembly of FIG. 1 in the deployed configuration.

FIG. 7 is a front perspective view of a cleat assembly for use with the main bracket assembly of FIG. 1.

FIG. 8 is a rear/side perspective view of the cleat assembly of FIG. 7.

FIG. 9 is a series of views of a cleat member suitable for use with the cleat assembly of FIG. 7.

FIG. 10 is a perspective view of a ladder stiffening system including the main bracket assembly of FIG. 1 in a deployed configuration and the cleat assembly of FIG. 7 attached to a ladder.

FIG. 11 is a perspective view of an outboard side of an alternative embodiment of a ladder stiffening main bracket assembly.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

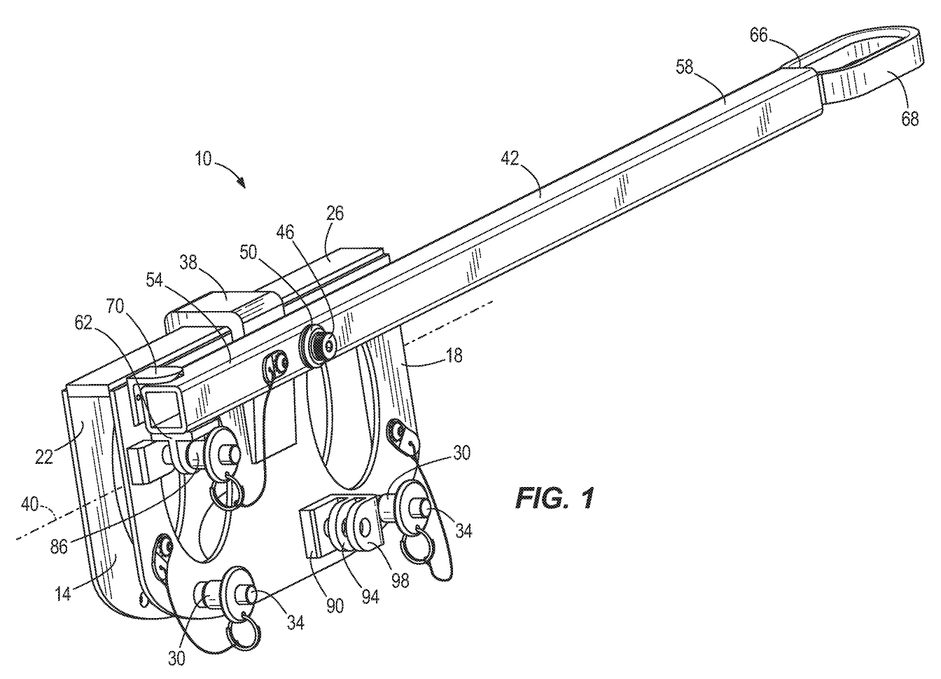

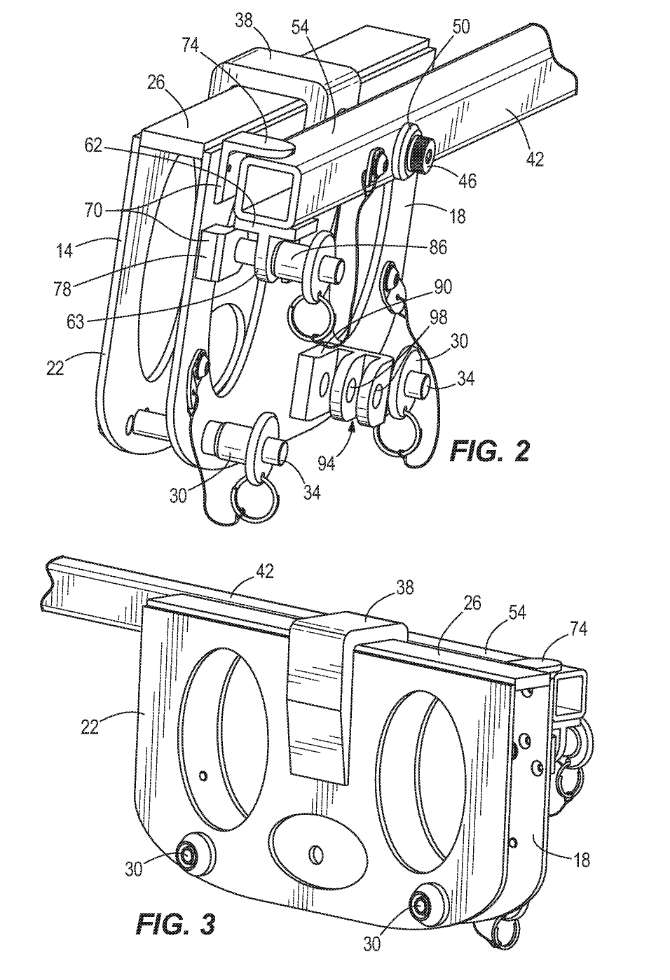

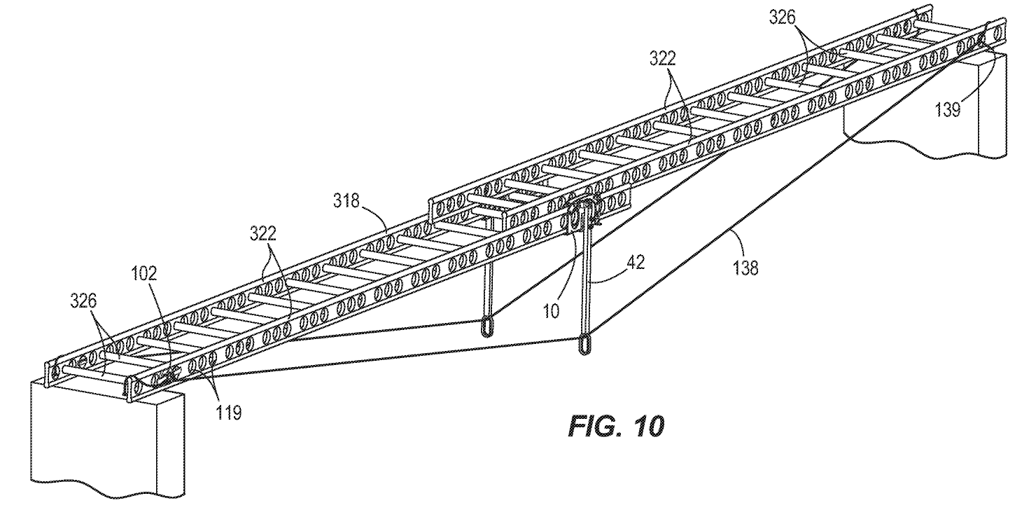

FIGS. 1-6 illustrated a bracket assembly 10 for increasing a stiffness of a ladder, such as an extension ladder 318 as shown in FIG. 10. The assembly 10 includes a main body portion 14 having a generally U-shaped cross section and including an outboard side plate 18, an inboard side plate 22, and a top plate 26 extending between the outboard side plate 18 and the inboard side plate 22. The main body portion 14 defines an axis 40 extending through the space the space that receives the ladder 318 when the bracket assembly 10 is secured to the ladder (e.g., the space between the side plates 18, 22, and the top plate 26). When the bracket assembly 10 is secured to the ladder 318 the axis 40 is substantially aligned with a length direction of the ladder 318.

Each side plate 22, 26 includes a pair of axially aligned securement openings (not shown) positioned adjacent an opposite edge of the side plates 22, 26 as the top plate 26. The securement openings are spaced a distance from the top plate that is slightly larger than the height of the rails 322 of the ladder 318 to which the assembly 10 is configured to be attached. Each pair of securement openings is configured to receive a respective locking pin 30 for securing the main body portion 14 to the ladder 318. Although a variety of locking pins may be used, the illustrated locking pins 30 are positive lock, double ball detent locking pins that include a push button 34 that allows the pins to be inserted and removed through the openings in the side plates 18, 22.

The bracket assembly 10 also includes a generally U-shaped swivel pad 38 that is located substantially along a midline of the main body portion 14 and extends from the inboard side plate 22, over the top plate 26, and around to the outboard side plate 18. In the illustrated embodiment, an elongated extension member 42 is pivotally coupled to the swivel pad 38 by a pivot bolt 46 that extends through extension member 42 and into the swivel pad 38. One or more bushings 50 may be provided between the pivot bolt 46, the extension member 42, and the swivel pad 38 to facilitate pivotal movement of the extension member 42 about the pivot bolt 46. In some embodiments the pivot bolt 46 may be secured to the swivel pad 38 by one or more set screws (not shown), which help to prevent gradual extraction or loosening of the pivot bolt 46 during use of the assembly 10.

In the illustrated configuration the swivel pad 38 has a thickness greater than that of the outboard side plate 18. The swivel pad 38 may also be formed of a material having greater strength than the material that forms the outboard side plate 18. In both regards the swivel pad 38 provides a more robust structure for pivotal mounting of the extension member 42 which, as will become apparent, carries a relatively large portion of the loads exerted upon the assembly 10 when the assembly 10 is in use.

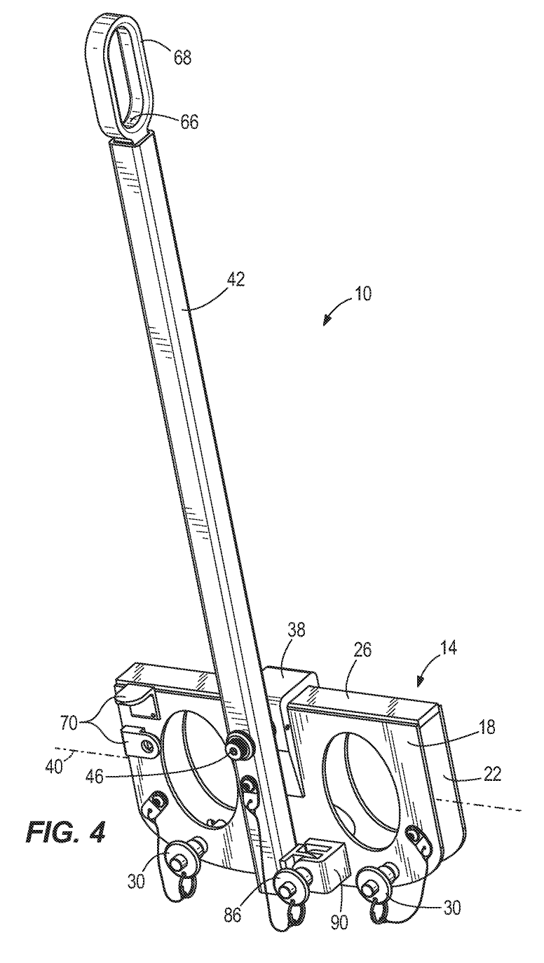

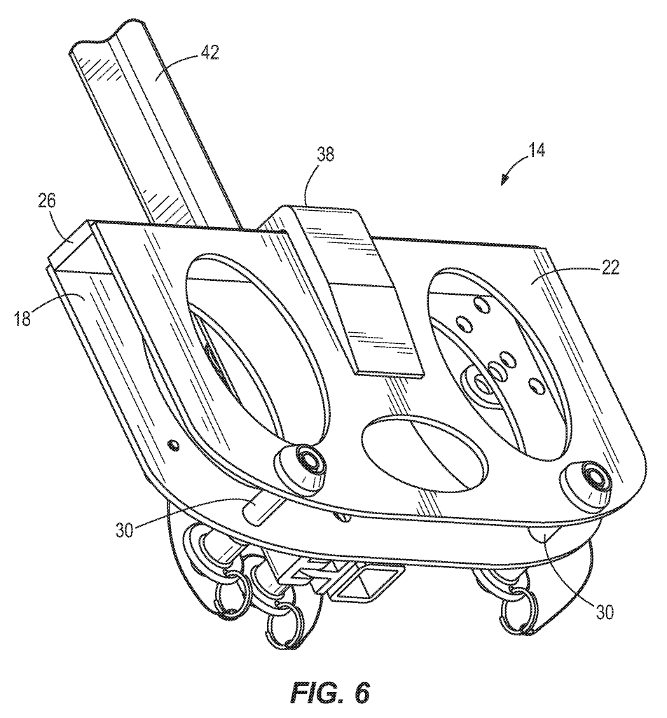

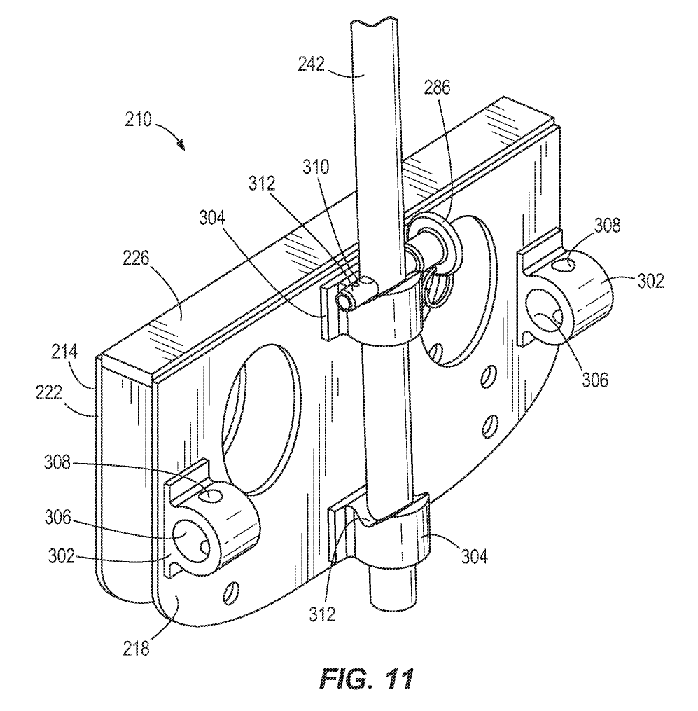

The extension member 42 is movable between a stowed position (FIGS. 1-3) in which the extension member 42 is substantially parallel with the axis 40, and a deployed position (FIGS. 4 and 6) in which the extension member 42 is generally perpendicular to the axis 40. While the embodiment shown in FIGS. 1-6 is moveable by pivoting about the pivot bolt 46, other embodiments, including the embodiment of FIG. 11, may move differently between the stowed and deployed positions, as discussed further below.

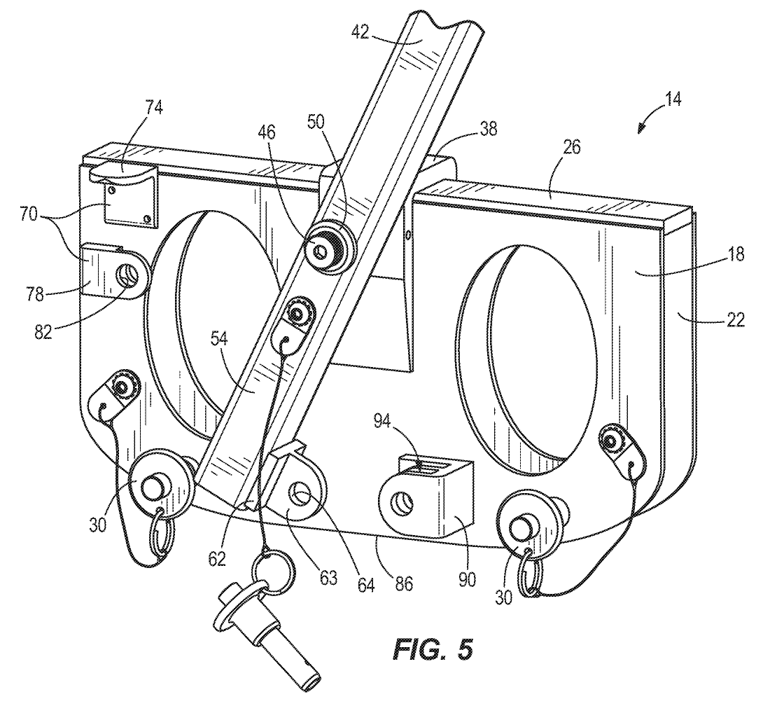

The extension member 42 includes a proximal end 54 proximal to the main body portion 14 and a distal end 58 spaced from the main body portion 14. The proximal end 54 includes a stop member 62 for securing the extension member 42 in the stowed or deployed position. In the illustrated configuration the stop member 62 is in the form of a projection 63 having a securement hole 64 (FIG. 5) extending therethrough in a direction generally parallel to an axis of the pivot bolt 46. The distal end 58 of the extension member 42 includes a line guide 66 (FIGS. 1 and 4) generally in the form of a curved surface that receives and guides a line (discussed below) when the assembly 10 is in use. In the illustrated construction, the line guide 66 defines a portion of a handle member 68 that may be used to move the extension member 42 between the stowed and deployed positions. Moving the extension member 42 from the stowed position to the deployed position increases a distance between the line guide 66 and the axis 40. Thus, when the extension member 42 is in the stowed position the line guide 66 is relatively close or proximate to the axis 40, and when the extension member 42 is in the deployed position the line guide 66 is spaced away from the axis 40.

The assembly 10 also includes a stowed position stop bracket 70 coupled to the outboard side plate 18 in a location that allows the stop member 62 of the extension member 42 to be secured thereto when the extension member 42 is in the stowed position. More specifically, the stowed position stop bracket 70 includes a generally L-shaped stopping portion 74 that engages the proximal end 54 of the extension member 42 when the extension member 42 is in the stowed position and prevents the extension member 42 from pivoting beyond the stowed position. The stowed position stop bracket 70 also includes a latching portion 78 including a projection positioned generally below the stopping portion 74 and defining a first latching hole 82 (FIG. 5) having an axis substantially parallel to the axis of the pivot bolt 46. The latching portion 78 is positioned such that when the proximal end 54 of the extension member 42 engages the stopping portion 74 the securement hole 64 of the stop member 62 is substantially aligned with the first latching hole 82 of the latching portion 78. A locking pin 86, which may be similar in form to the locking pins 30, may be extended through the securement hole 64 and the first latching hole 82 to secure the extension member 42 in the stowed position.

The assembly 10 also includes a deployed position stop bracket 90 that functions similarly to the stowed position stop bracket 70 but secures the extension member 42 in the deployed position. The illustrated deployed position stop bracket 90 has a generally M-shaped cross section. An outboard gap 94 of the deployed position stop bracket 90 is configured to receive the projection 62 of the stop member 62 when the extension member 42 is in the deployed position. When this occurs, the securement hole 64 is substantially aligned with a pair of second latching holes 98 formed in the deployed position stop bracket 90 such that the locking pin 86 may be extended through the securement hole 64 and the second latching holes 98, thereby securing the stop member 62 to the deployed position stop bracket 90 and securing the extension member 42 in the deployed position.

While the above-described example utilizes locking pins 30, 86 to secure the assembly 10 to the ladder and to secure the extension member 42 in the stowed and deployed positions, several alternative structures may also or alternatively be used. For example, the stowed position stop bracket 70 and/or the deployed position stop bracket 90 may include a spring loaded or otherwise biased latching mechanism, such as a clamp, snap, spring loaded ball, or the like, that securely engages the stop member 62 or other structure provided on the extension member 42 when the extension member 42 is moved to the stowed or deployed position. A button, lever, twist lock, or other release mechanism may then be used to release the stop member 62 from the alternative structure. Similarly, several alternatives to the locking pins 30 may be used to secure the assembly 10 to the ladder 318, including, for example, bungees, pivoting clamp mechanisms, or a pivoted panel similar to the top bracket that can be moved between secured and unsecured positions to prevent or permit removal of the main body portion 14 from the ladder 318. As shown in the Figures, one or more lanyards, typically in the form of relatively light gauge wires, may be used to secure the locking pins 30 to the main body portion 14 and/or to secure the locking pin 86 to the extension member 42, for example by providing tabs, holes, or other features on the main body portion 14 and/or the extension member 42 to which the lanyards may be secured.

In the illustrated example the main body portion 14 is formed of aluminum plates that are welded together. Other materials and construction techniques may also or alternatively be used. For example, the main body portion 14 and the extension member 42 may be formed of composite material while the stop member 62, and the stowed and deployed position stop brackets 70, 90 may be formed of aluminum and bolted or otherwise secured to the composite main body portion and extension member 42. These and other components may include one or more of castings, forgings, weldments, and combinations thereof.

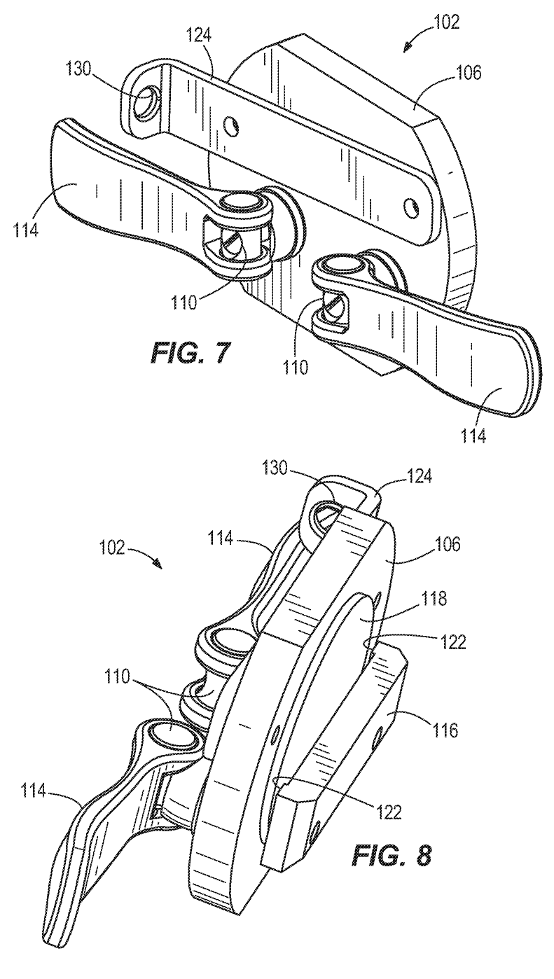

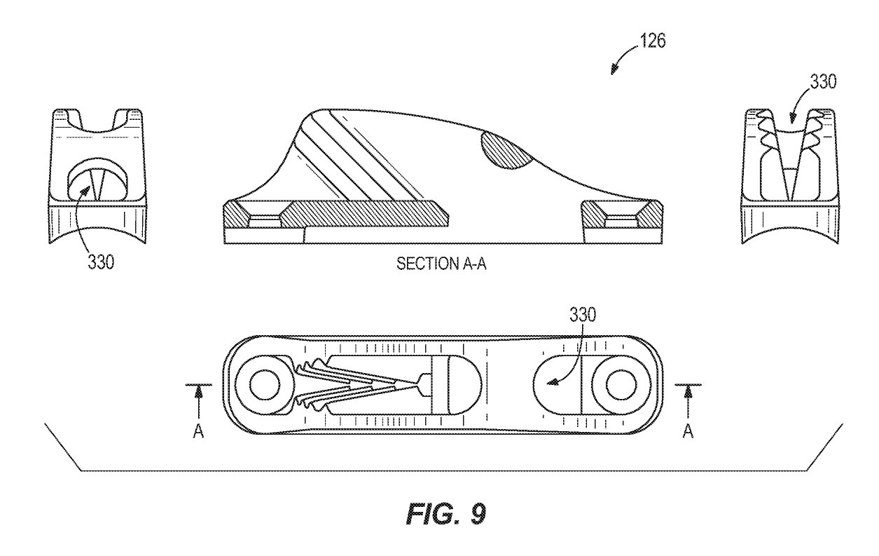

Referring now to FIGS. 7-9, a coupling member in the form of a cleat assembly 102 may be provided in combination with the assembly 10 and includes a generally oval-shaped base plate 106 adapted for placement against an outboard face of a ladder (such as the ladder 318) to which the cleat assembly 102 is configured to be mounted. The base plate 106 rotatably supports a pair of screw clamps 110 including pivoting handles 114 that may be pivoted and rotated to tighten or loosen the cleat assembly 102 to the ladder 318. More specifically, the screw clamps 110 include threaded shanks that extend through the base plate and thread into a clamping bar 116 (FIG. 9) positioned on an inboard side of the base plate 106. The inboard side of the base plate 106 includes a relatively thin projection 118 configured to fit inside a cutout 119 (FIG. 10) that may be provided in the outboard face of the ladder 318 to which the cleat assembly 102 may be secured. In the illustrated configuration the projection 118 is circular to correspond with a circular cutout, although other configurations are possible. The clamping bar 116 includes a length greater than a diameter of the circular projection 118, and the outer ends of the clamping bar 116 are provided with locking jaws 122 that extend in an outboard direction for engagement with an inboard side of the ladder's outboard wall. In this manner, when the screw clamps 110 are tightened the clamping bar 116 is drawn toward the base plate 106 such that the outboard wall of the ladder 318 is firmly clamped between the base plate 106 and the locking jaws 122 thereby securing the cleat assembly 102 to the ladder 318.

The cleat assembly 102 also includes a generally L-shaped line guide 124 that functions as a mounting surface for a line securement member which, in the illustrated configuration, is defined by the cleat member 126 shown in FIG. 10. The illustrated cleat member 126 may be or include a CLAMCLEAT® brand boom cleat available from Clamcleats Limited of Hertfordshire England. The illustrated cleat member 126 is well suited for use in the ladder stiffening systems described herein because it allows for quick and accurate adjustments to the length of the line. The cleat member 126 may be secured, e.g. by fasteners, to the line guide 124 and the line may be extended through a line opening 130 defined on one end of the line guide 124 and into the cleat member 126. The illustrated cleat member 126 includes a fluted throat 130 configured to receive and secure a line when the line is moved to a securing position.

While the illustrated cleat member 126 is particularly well suited for use in the present application, alternative line securement members using different cleat configurations or, in some embodiments no cleat at all, may also be used. For example, in some embodiments, a standard dock or deck type cleat or substantially any other structure that facilitates the rapid securement of the line thereto may also or alternatively be used. In some embodiments, the line may simply be tied or hooked at the appropriate length to one of the ladder rungs or using a suitable knot or hook to which the line may be secured.

With reference to FIG. 10, the bracket assembly 10, the cleat assembly 102, and an elongated line 138 are shown secured to the ladder 318. While a variety of line types may be used in combination with the assembly 10 and cleat assembly 102, preferred varieties of line typically include braided ropes have a diameter between about one-eighth and one-quarter of an inch, and have exceptionally low stretch elongation. In some embodiments one end of the line 138 may include a hook or loop 139, which may be formed of the same material as the line or of a different material, such as, for example, a strap-like material, which may provide better abrasion resistance or other performance when repeatedly hooked over one end of the ladder 318 as discussed below. A second end of the line 138 may be provided with indicia at various locations along its length. The indicia may be or include stripes, stripes in combination with letters and/or numbers, or distinct changes in the color of the line, any or all of which may be associated with a predetermined length of line 138 that is suitable for use with a predetermined length of ladder 318. By way of example only, for a ladder length of 10 feet, the suitable line length may be 11 feet. Accordingly, a stripe or other indicia may be provided at a location 11 feet from the first end of the line 138 and the indicia may be associated (by writing on the line itself or by knowledge of the user) with a ladder length of 10 feet. Other indicia may be provided for other ladder lengths such that the working length of the line 138 may be quickly adjusted or selected for a given length of ladder 318.

“Line” as used herein may include substantially any type of line or rope, including braided and unbraided varieties formed of natural fibers, synthetic fibers, and combinations thereof, including wire ropes, cables, chains, and the like. Lines made from fibers in the aramid family, such as TECHNORA® brand rope, may be particularly well suited because they tend to be relatively light while possessing good flexibility and low elongation at break.

Accordingly, a ladder stiffening system may be provided comprising the assembly 10, the line 138, and optionally the cleat assembly 102. As noted above, when the cleat assembly 102 is excluded from the system the line 138 may be tied or otherwise secured directly to rungs 326 or rails 322 of the ladder 318. In some applications, including the application of FIG. 10, a pair of ladder stiffening systems may be provided such that one ladder stiffening system can be secured to each rail 322 of the ladder 318.

An exemplary method of use of the system including the assembly 10, the rope, and the cleat assembly 102 will now be described with reference to FIG. 10. Although the following explanation describes installation of one system on one rail 322 of a ladder 318, it should be appreciated that the steps are repeated for the second rail 322 of the ladder 318 if two systems are being used.

The ladder 318 is initially adjusted to the desired length. One end of the line 138 is secured to one end of the ladder 318. This may be accomplished in a variety of ways, including tying the line 138 to the rung 326 or other feature of the ladder 318. In the illustrated configuration, the line 138 is secured to one end of the ladder 318 by positioning the loop 139 provided on the end of the line 138 over the end of a rail 322.

Before or after securing one end of the line 138 to the ladder 318, the bracket assembly 10 is secured to the ladder 318. With the extension member 42 in the stowed position, the pins 30 are removed from the securement openings and the main body portion 14 is positioned over one of the rails 322 of the ladder 318 at approximately the mid-point of the ladder 318. The main body portion 14 is positioned such that the top plate 26 is on the side of the ladder that will be in tension when a load is applied to the ladder. Thus, in the configuration shown in FIG. 10, the top plate 26 is positioned on the bottom of the ladder rail 322. The main body portion 14 is held in position and the pins 30 are reinserted into the securement openings thereby securing the main body portion 14 to the ladder rail 322.

The line 138 is passed through the handle member 68 and the line 138 and the cleat assembly 102 are taken to the opposite end of the ladder 318. If the ladder 318 is compatible with the cleat assembly 102, the cleat assembly 102 is secured to the ladder 318 as discussed elsewhere herein. If the ladder 318 is not compatible with the cleat assembly 102 the line 138 may be tied to a ladder rung 326, to the rail 322, or to any other suitable structure adjacent the end of the ladder 318. In some embodiments, the line 138 may be of a predetermined length for use with a ladder of a fixed and predetermined length, and may include a hook or loop at both ends such that when both ends are secured to the ladder 318 an appropriate amount of slack is provided in the line 138. In other embodiments, including the illustrated embodiment of FIG. 10, the line 138 is attached to the ladder 318 such that the correct amount of slack is provided in the line 138. As discussed above, some embodiments of the line 138 include stripes or other indicia to indicate to a user where to secure the line 138 to the ladder 318 or to the cleat assembly to ensure the correct amount of slack is provided in the line 138.

For ladders 318 that are compatible with the cleat assembly 102, the cleat is secured to the ladder as follows: the screw clamps 110 are loosened to increase clearance between the clamping bar 116 and the circular projection 118. The clamping bar 116 is maneuvered through the opening 119 provided in the ladder rail 322 until the circular projection 118 is seated in the opening 119. The screw clamps 110 are then tightened to draw the locking jaws 122 firmly against the inboard surface of the ladder rail 322, thereby clamping the ladder rail 3221 between the base plate 106 and the clamping bar 116. With the cleat assembly 102 firmly secured to the ladder rail 322, the line 138 is extended through the line opening 130 and into the throat 330 of the cleat member 126 (see FIG. 9). The length of the line 138 is adjusted, for example by aligning the indicia on the line 138 corresponding to the ladder length with the line opening 130, and the line 138 is secured within the throat 330 of the cleat member 126 in a known manner. Generally speaking, when the line 138 is properly secured to the ladder 318 and the extension member 42 is in the stowed position, the line 138 will the proper amount of slack. It should be appreciated that the proper amount of slack in the line will depend upon the specific type of line 138 that is used in addition to the length and stiffness of the ladder 318 and the length and stiffness of the extension member 42, among other factors that should be well understood by those skilled in the art.

To deploy the extension member 42, the locking pin 86 is withdrawn from the first latching hole 82 and the securement hole 64 (see FIG. 5), thereby releasing the extension member 42 for pivotal movement about the pivot bolt 46. The user then moves the extension member 42 from the stowed position (FIG. 1) to the deployed position (FIGS. 4 and 10), and inserts the locking pin 86 into the second latching holes 98 and the securement hole 64, thereby securing the extension member 42 in the deployed position.

Moving the extension member from the stowed position to the deployed position not only removes the slack from the line 138 but also pretensions the line 138. With the extension member 42 in the deployed position and the line guide 66 spaced a perpendicular distance away from the ladder rail 322, a triangulated truss structure is formed comprising the ladder 318, the line 138, and the extension member 42. In this configuration the line 138 is in tension, the extension member 42 is in compression, and the ladder 318 is subjected to a bending moment that is opposite the bending moment applied when the ladder is loaded. By preloading the components in this manner, the truss structure provided by the combined ladder 318, line 138, and bracket assembly 10 has an increased resistance to bending compared to the ladder 318 alone, which results in reduced ladder deflection under a given load.

As shown in FIG. 10, when the ladder 318 is supported on its ends, loads applied to the top of the ladder 318 are transferred through the bracket assembly 10 and extension member 42 into the line 138, which increases tension on the line 138. Because the line 138 has a high resistance to elongation the line 138 carries these tensile loads with relatively little stretching and transfers the loads to the ends of the ladder 318. The result is a reduced amount of bending or deflection along the ladder 318 relative to when the same load is placed on the ladder 318 without the bracket assembly 10 and line 138 installed.

To remove the bracket assembly 10, the locking pin 86 is removed from the second latching holes 98 and the securement hole 64 and the extension member 42 is pivoted from the deployed position to the stowed position. The locking pin 86 is inserted into the first latching hole 82 and the securement hole to secure the extension member 42 in the stowed position, and the line 138 and the cleat assembly 102, if used, are removed from the ladder.

FIG. 11 is an alternative embodiment of a bracket assembly 210. The bracket assembly 210 includes main body portion 214 formed by outboard side plate 218, inboard side plate 222, and top plate 226. However, in the embodiment of FIG. 10, the extension member 242 is not pivotally mounted to the main body portion 214 but is instead moveable between a first set of mounting blocks 302 associated with the stowed position and a second set of mounting blocks 304 associated with the deployed position. The mounting blocks 302, 304 all define openings 306 sized to receive the extension member 242, which in the illustrated configuration means the openings are generally circular. The openings 306 of the mounting blocks 302 are substantially axially aligned as are the openings in the mounting blocks 304.

The mounting blocks 302 also include cross apertures 308 extending perpendicularly through the mounting blocks 302 and intersecting the openings 306. One or both of the cross apertures 308 may be used to secure the extension member 242 in the stowed position by extending a locking pin 286 through the cross apertures 308 and through a cross bore 310 provided in the extension member 242. The mounting blocks 304 include generally V-shaped notches 312 formed on one side thereof with the notches oriented to face generally toward the top plate 226. The notches receive the locking pin 286 when the extension member 242 is in the deployed position, as discussed below.

To move the extension member 242 from the stowed position to the deployed position, the locking pin 286 is removed from the cross aperture 308 and the extension member 242 is withdrawn from the first set of mounting blocks 302. The end of the extension member 242 with the cross bore 310 (e.g., the end opposite the end with the line guide—not shown) is then inserted into the second set of mounting blocks 304. When the ends of line are secured to the ladder and the line is positioned in the line guide, the line tends to urge the extension member 242 into the mounting blocks 304. To tighten the line, the extension member 242 is pressed in the upward direction with respect to FIG. 11, which is against the force applied by the rope, until the cross bore 310 moves beyond one of the mounting blocks 304. The locking pin 286 is then inserted into the cross bore 310 and the extension member 242 is released. The tension in the line urges the locking pin 286 against the V-shaped notch in the mounting block 304, which prevents further movement of the extension member 242 relative to the main body portion 214. Those skilled in the art will recognize that the general operating principles of the bracket assembly 10 and the bracket assembly 210 are substantially the same.

Various features of the invention are set forth in the following claims.

What is claimed is:

1. A bracket assembly for stiffening a ladder, the assembly comprising:
a main body portion securable to the ladder and defining an axis; and
an extension member coupled to the main body portion and movable with respect to the main body portion between a stowed position and a deployed position, the extension member including a distal end defining a guide portion that is closer to the axis when the extension member is in the stowed position than the guide portion is to the axis when the extension member is in the deployed position.

2. The assembly of claim 1, wherein the main body portion includes an outboard plate, an inboard plate, and at least one securement opening extending through at least one of the outboard plate and the inboard plate for securement of the main body portion.

3. The assembly of claim 2, wherein the main body portion includes a generally U-shaped cross section including a top plate extending substantially parallel to the axis and positioned opposite the securement opening.

4. The assembly of claim 1, wherein the extension member is substantially parallel to the axis when in the stowed position and substantially perpendicular to the axis when in the deployed position.

5. The assembly of claim 1, wherein the extension member includes a proximal end defining a stop member for securing the extension member in one of the stowed position and the deployed position.

6. The assembly of claim 5, further comprising a stowed position stop bracket coupled to the main body portion and a deployed position stop bracket coupled to the main body portion, wherein the stop member is securable to the stowed position stop bracket to secure the extension member in the stowed position and wherein the stop member is securable to the deployed position stop bracket to secure the extension member in the deployed position.

7. The assembly of claim 5, further comprising a first locking pin extending through the main body portion and a second locking pin selectively extendable through either:
the stop member and the stowed position stop bracket to secure the extension member in the stowed position, or
the stop member and the deployed position stop bracket to secure the extension member in the deployed position.

8. The assembly of claim 1, wherein the extension member is pivotally coupled to the main body portion for movement between the stowed and deployed positions.

9. The assembly of claim 1, wherein the distal end of the extension member includes a handle, and wherein a portion of the handle defines the guide portion.

10. A system for stiffening a ladder, the system comprising:
A bracket assembly securable to the ladder and including a main body portion and an extension member coupled to the main body portion, the extension member being movable between a stowed position and a deployed position and including a distal end defining a guide portion; and,
a line having a first end securable to one end of the ladder and a second end securable to an opposite end of the ladder, the line extendable through and supportable by the guide portion, wherein the extension member is moveable from the stowed position to the deployed position to apply tension to the line.

11. The system of claim 10, wherein with the bracket assembly secured to a middle portion of the ladder, the extension member in the deployed position, the first end of the line secured to the one end of the ladder, the second end of the line secured to the opposite end of the ladder, and the line extending through and over the guide portion, the line, the bracket assembly, and the ladder cooperate to define a triangulated truss structure.

12. The system of claim 10, wherein the main body portion defines an axis, and wherein the extension member is substantially parallel to the axis when in the stowed position and substantially perpendicular to the axis when in the deployed position.

13. The system of claim 10, wherein the main body portion includes an outboard plate, an inboard plate, and at least one securement opening extending through at least one of the outboard plate and the inboard plate for securement of the main body portion to the ladder.

14. The system of claim 10, wherein the extension member includes a proximal end defining a stop member for securing the extension member in one of the stowed position and the deployed position.

15. The system of claim 14, wherein the bracket assembly further includes a stowed position stop bracket coupled to the main body portion and a deployed position stop bracket coupled to the main body portion, wherein the stop member is securable to the stowed position stop bracket to secure the extension member in the stowed position and wherein the stop member is securable to the deployed position stop bracket to secure the extension member in the deployed position.

16. The system of claim 15, wherein the bracket assembly further includes a first locking pin extending through the main body portion and a second locking pin selectively extendable through either:
the stop member and the stowed position stop bracket to secure the extension member in the stowed position, or
the stop member and the deployed position stop bracket to secure the extension member in the deployed position.

17. The system of claim 10, wherein the extension member is pivotally coupled to the main body portion for movement between the stowed and deployed positions.

18. The system of claim 10, wherein the distal end of the extension member includes a handle, and wherein a portion of the handle defines the guide portion.

19. The system of claim 10, further comprising a coupling member securable to the opposite end of the ladder and including a line securement member for securing the second end of the line to the coupling member,

20. The system of claim 10, wherein the second end of the line includes a plurality of indicia at predetermined distances from the first end of the rope, each indicia corresponding to a respective length to which the ladder may be adjusted.
